(19) United States
(12) Patent Application Publication
(10) Pub. No.: US 2003/0107790 A1
(43) Pub. Date: Jun. 12, 2003

(54) Optical wavelength conversion device

(76) Inventor: Shoichi Kishimoto, Osaka (JP)

Correspondence Address: WHITHAM, CURTIS & CHRISTOFFERSON, P.C., Suite 340, 11491 SUNSET HILLS ROAD, P.O. BOX 9204, RESTON, VA, 20190, US

(21) Appl. No.: 10/291,688

(22) Filed: Nov. 12, 2002

(30) Foreign Application Priority Data
Nov. 12, 2001 (JP) P2001-346687

(51) Int. Cl. G02F 1/00; G02B 26/00

(52) U.S. Cl. 359/237

(57) ABSTRACT

An optical wavelength conversion device comprising: a modulating signal generating unit for generating a modulating signal; an optical modulating unit for modulating input light by the modulating signal; and wavelength select means for extracting only a necessary component from an optical signal generated by the optical modulating unit. In the optical wavelength conversion device, the optical modulating unit may be an amplitude modulator or a phase modulator. The modulating signal may be an electrical signal or an optical signal. When the modulating signal is an optical signal, the optical signal consists preferably of light of a plurality of wavelength components.

### BACKGROUND OF THE INVENTION

The present invention relates to a method of converting a wavelength of light, and a device for converting a wavelength of light by using the wavelength converting method. More particularly, the invention relates to a device for converting a wavelength of light, which is well adaptable for technique fields of, for example, optical communication and optical measurement.

Optical fiber communication network having played a key role in the communication field is of long standing. With progress of information-oriented society, communication speed and communications capacity become insufficient. A wavelength division multiplexing (WDM) communication system has attracted the attention as a communication system capable of greatly increasing the communication speed and communications capacity. Light of different wavelengths are passed through one optical communication channel, and different signals are transmitted by the light of different wavelengths. In the WDM communication system, the necessity of converting the wavelengths of the carrier waves to other ones occurs because of signal bypassing at the time of communication interrupt, signal sorting, signal assignment based on traffic congestion conditions, etc.

One of conventional wavelength conversion technique is that a light or optical signal is demodulated into an electric signal at the receiver, and then an optical carrier wave of a different frequency is modulated by the demodulated electric signal. Japanese Patent Laid-Open No. 10-221725 discloses an interference type wavelength conversion circuit. To the wavelength conversion, the disclosed circuit uses a wavelength conversion laser utilizing a semiconductor laser structure, and changes the interference condition by utilizing a variation of a refractive index, which is caused by a variation of a carrier density at a semiconductor gain part. The wavelength multiplex optical transmission system disclosed in Japanese Patent Laid-Open No. 2000-81643 uses the four-wave mixing (FWM) as one form of the tertiary nonlinear optical effect. Japanese Patent Laid-Open No. 7-92517 discloses an optical frequency converting element using a rotating half-wave plate.

Those conventional techniques suffer from the following problems, however.

In the wavelength conversion technique to convert the light signal into the electric signal and then to modulate another carrier wave by the electric signal, the conventional device components may directly be used for constructing the device for the wavelength conversion technique. Accordingly, it is easy to realize this technique. However, the device construction is complex, so that the device size is large and the power consumption is large. Further, the electric signal processing speed is rate-determined and hence, this technique is inappropriate for increasing the communication speed

In the conventional wavelength conversion laser utilizing the semiconductor laser structure, a variation rate of the carrier density in the semiconductor laser is rate-determined. In this respect, the technique is also inappropriate for increasing the communication speed. The wavelength multiplex optical transmission system, which uses the FWM, is characteristically featured in “the wavelength of the wavelength multiplex signal light is offset to a wavelength of the pumping light so as not to overlap with each other”, as disclosed. Accordingly, there are limitations on the wavelengths of the input light, output light, and pumping light, and hence, the wavelength conversion is allowed with certain limits. In the case of the optical frequency converting element using a rotating half-wave plate, it is necessary to propagate a circularly polarized wave in order to produce the effect of the rotating half-wave plate. Further, use of the quantum well structure makes the device structure complicated. Thus, any of the conventional techniques has disadvantages of its inappropriateness for increasing the communication speed, complexity of the device structure, and the like.

The present invention has been made to solve the problems of the conventional techniques, and has an object to provide a high-performance optical wavelength conversion device which is simple in construction, operable at high speed and stably. To achieve the object, in the invention, an input light is modulated to generate wavelength components different from those of the input light. Only the necessary component is extracted as an output light by wavelength select means, thereby effecting the wavelength conversion of the input light. Accordingly, a large freedom of the wavelengths of the input light and output light is secured.

### SUMMARY OF THE INVENTION

To solve the problems of the conventional techniques, there is provided an optical wavelength conversion device comprising: a modulating signal generating unit for generating a modulating signal; an optical modulating unit for modulating input light by the modulating signal; and wavelength select means for extracting only a necessary component from an optical signal generated by the optical modulating unit.

In the optical wavelength conversion device, the optical modulating unit may be an amplitude modulator or a phase modulator. The modulating signal may be an electrical signal or an optical signal.

When the modulating signal is an optical signal. the optical signal consists preferably of light of a plurality of wavelength components.

The optical wavelength conversion device of the invention is capable of performing a wavelength conversion at high speed and good stability, and with high performances. Further, there is no need of converting the optical signal to the electrical signal, during the process of the wavelength conversion of the optical signal. This feature provides an optical wavelength conversion device operable at extremely high speed.

The modulating signal may be an electrical signal or an optical signal.

When the modulating signal is an optical signal the optical signal consists preferably of light of a plurality of wavelength components.

A wavelength conversion width is defined by a beat component containing a plurality of optical signal modulating signals to thereby ensure a wavelength conversion at the large conversion width. Further, a quantity of wavelength conversion may be set at a desired value.

These features are well applicable for the channel conversion in the optical communication of the DWDM communication system.

The present disclosure relates to the subject matter contained in Japanese patent application No. P2001-346687 (filed on Nov. 12, 2001), which is expressly incorporated herein by reference in its entirety.

### BRIEF DESCRIPTION OF THE DRAWINGS

FIG. 1 is a block diagram showing an arrangement of an optical wavelength conversion device constructed according to the present invention.

FIG. 2 is a block diagram showing another arrangement of an optical wavelength conversion device constructed according to the invention.

FIG. 3 is a block diagram showing an arrangement of an optical modulator which may be used for the optical wavelength conversion device of the invention.

FIG. 4 is a block diagram showing an arrangement of a modulating signal generator which may be used for the optical wavelength conversion device of the invention.

### DETAILED DESCRIPTION OF THE PREFERRED EMBODIMENTS

The preferred embodiments of the present invention will be described with reference to the accompanying drawings.

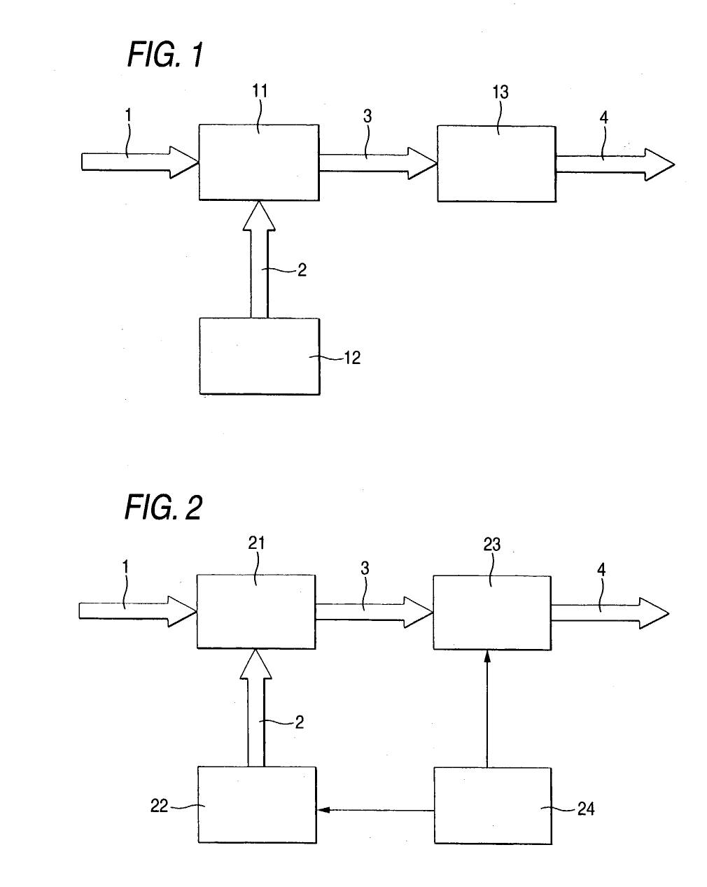

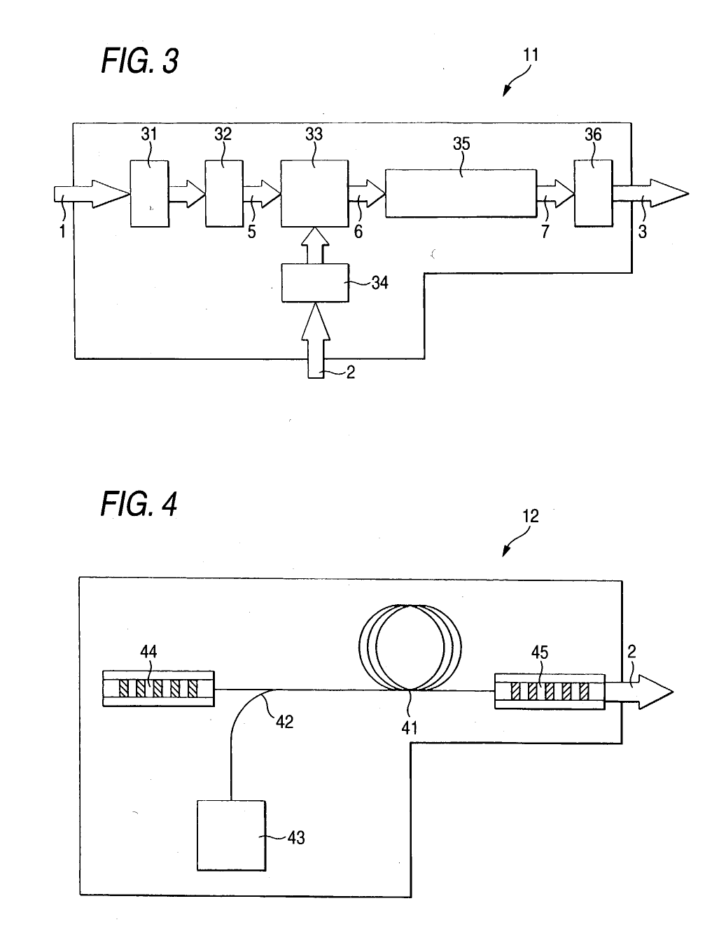

A basic construction of an optical wavelength conversion device constructed according to the present invention is shown in FIG. 1. An input signal light 1 is modulated by a modulating signal 2 (electric signal) output from a modulating signal generator 12, in an optical modulator 11. An output signal light 3 from the optical modulator 11 contains an input signal light component and a wavelength-converted signal light component. A wavelength select means 13 selects only a necessary light component from the output signal light, and outputs the selected one in the form of an output signal light 4 as a wavelength-converted input signal light 1.

Operation of the ion beam irradiation apparatus of the invention will be described when the optical modulator 11 is an amplitude modulator.

An input signal light 1 may be developed on an angular frequency axis, and is mathematically given by the following expression (Expression 1).

I1=(see the attached sheet) [Expression 1]

where

I1=intensity I1 of the input signal light 1

Ic=amplitude of the carrier light component

ωc=the number of angle vibration of the carrier light component

i=natural number

Ipi=amplitude of the i-th component when the signal light component is developed

ωi=the number of angle vibration of the i-th component when the signal light component is developed

αi=phase component of the i-th component when the signal light component is developed

t=time

The modulating signal 2 is given by the following expression ([Expression 2]) when it is a continuous wave signal. In the [Expression 2], I2 is an intensity of the modulating signal 2, and Is and ωs are an amplitude and the number of angle vibration of the modulating signal 2.

I2=Is·sin(ωₛ)t [Expression 2]

The optical modulator 11 is an amplitude modulator. A relation among the intensity I1 of the input signal light, intensity I2 of the modulating signal, and intensity I3 of the output signal light from the optical modulator is given by the following expression ([Expression 3]).

I3={1+(1/Ic)I2}I1 [Expression 3]

Accordingly, the intensity I3 of the output signal light 3 from the optical modulator 11 is given by the following expression ([Expression 4]).

I3=(see the attached sheet) [Expression 4]

In the above expression ([Expression 4]), the second and third terms indicates that when the phase is shifted by π/2, the frequency of the input signal light 1 is shifted to the upper and lower sides on the angular frequency axis by an amount corresponding to the modulating signal 2.

If a condition given by the following expression ([Expression 5]), viz., the frequency of the modulating signal 2 is selected to be higher than a spread of the frequency of the input signal light 1 on the frequency axis, is satisfied, only one of the frequency shifted components can be extracted y the wavelength select means 13.

ωₛ>2max (ω₁) [Expression 5]

Thus, the optical wavelength conversion device of the invention is capable of shifting the frequency of the input signal light 1 to the upper and lower sides by an amount of the frequency of the modulating signal 2.

The frequency of the modulating signal 2 may be set at a desired frequency value if the condition of the expression ([Expression 5]), viz., it is higher than a spread of the frequency of the input signal light 1 on the frequency axis, is satisfied. Therefore, where the optical wavelength conversion device of the invention is used, the wavelength of the input signal light 1 is converted as desired.

Advantages to be specially noteworthy, which are produced when the optical wavelength conversion device of the invention is applied to the DWDM (dense wavelength division multiplexing) system, are 1) the condition ([Expression 5]) on the frequency is satisfied, and 2) any limitation is not placed on the operation of the optical wavelength conversion device. The reason for this is that in order that the DWDM system hold good, it is necessary that the channel components are clearly separated on the frequency axis. To this end, the channel interval is selected to be larger than a spread of the frequency of each channel. Accordingly, when the optical wavelength conversion device of the invention is used for the wavelength conversion among the channels in the DWDM system, the expression ([Expression 5]) must always be satisfied.

Other advantages of the present optical wavelength conversion device are that even if an optical modulator with inferior modulation distortion character is used for the optical modulator 11, the wavelength conversion characteristic is not adversely affected, and that it greatly contributes to the improvement of other characteristics of the optical modulator, such as modulation rate, and cost reduction of the whole device.

Let us consider a case where the character of the optical modulator contains a distortion component. The modulation characteristic cannot be expressed by the expression ([Expression 3]), but may be expressed by polynomial approximation, as given by the following expression ([Expression 6]).

I3=(see the attached sheet) [Expression 6]

In this case, the intensity I3 of the output signal light 3 of the optical modulator is given by the following expression ([Expression 7]). In Expression 7, n=natural number, n=1 indicates a modulation characteristic not containing a distortion, and n≦2 corresponds to an n-order distortion characteristic. aₙ, bₙ, cₙ are each a constant.

I3=(see the attached sheet) [Expression 7]

A component originating from the n-order distortion characteristic has been converted to a frequency, which is separated from the frequency of the input signal light 1 by “n” times or greater as large as the frequency of the modulating signal. A component originating from the n-order distortion characteristic appears as a component on the frequency axis, which is different from the components as are converted by the amounts of the frequencies of the input signal light 1 and the modulating signal 2. Therefore, it is readily removed by the wavelength select means 13. And it does not appear on the output side of the wavelength select means 13, and hence it does not adversely affect the optical wavelength conversion device of the invention.

If the characteristic not dependent on the distortion characteristic of the optical modulator is well utilized, an optical switch may be used for the modulating means.

As given by the following expression ([Expression 8]), the optical switch functions to turn on and off light to be output.

I3=(see the attached sheet) [Expression 8]

Let us consider a case where the optical switch is driven at an angular frequency ωs, viz., an optical switch operating as indicated by the following expression ([Expression 9]). In Expressions 8 and 9, u and v are constants. Of those constants, the constant “u” is a loss of the input signal when the optical switch is in an on state, and the constant “v” is a leakage of the input signal when the optical switch is in an off state. In an ideal switch, u=1 and v=0. If an absolute value of “u” is larger than that of “v”, those do not adversely affect the operation of the optical wavelength conversion device of the invention.

I3=(see the attached sheet) [Expression 9]

If rearranging the above expression ([Expression 9]), then we have the following expression ([Expression 10])

I3=(see the attached sheet) [Expression 10]

The expression may be considered as a special case of the expression ([Expression 6]). Where the modulating means is used, the theory of the expression ([Expression 7]) holds for the output signal light 3m, without any change. In other words, the other components than the essential component are located at greatly remote positions on the frequency axis. Therefore, those components do not adversely affect the optical wavelength conversion device.

The optical switch having only the on/off function may be controlled at a high rate, when comparing with the general amplitude modulator in which some measure must be taken for its distortion characteristic. In this respect, such an optical switch is an effective means for realizing the optical wavelength conversion device.

While the description has been made about the case where the optical modulator 11 is the amplitude modulator, it should expressly be understood that similar characteristics are obtained also when the optical modulator 11 is a phase modulator.

An optical signal may be used for the modulating signal 2. A frequency of light is extremely higher than that of a radio wave. Therefore, sufficient wavelength conversion is secured.

If a variation component of the modulating signal 2, viz., a component corresponding to a beat of the modulating signal, which consists of a plurality of wavelength components, is applied to the optical modulator 11, the input light is modulated by the beat component of the modulating signal, which consists of a plurality of wavelength components.

Let us consider a case where the optical modulator 11 consists of means in which the relation among the intensity I1 of the input signal light, intensity I2 of the modulating signal, and the intensity I3 of the output signal light of the optical modulator is defined by the following expression ([Expression 11]), and a light signal defined by the following expression ([Expression 12]) is used for the modulating signal 2.

I2=

I3=(see the attached sheet) [Expression 11]

I2=(see the attached sheet) [Expression 12]

In the above expression ([Expression 11]), Ik is an amplitude of the modulating signal, and IB is a beat component of the modulating signal. When such a modulating signal 2 is input to the means, the output signal light 3 output from the optical modulator is mathematically expressed by the expression ([Expression 4]). A relation in which the input signal light 1 is shifted to the upper and lower sides on the angular frequency axis by the beat component of the modulating signal 2, is set up. Thus, also in this case, a necessary component is readily separated by use of the wavelength select means 13, and an optical wavelength conversion device may be constructed.

Even if the optical signal is used for the modulating signal 2, the waveform distortion problem in the optical modulator 11 is not created. The wavelength conversion amount (conversion amount of the optical frequency) is defined by the components of the optical modulating signal. Therefore, it may be varied over an extremely broad range.

In this respect, the present device excellently operates when it is applied to the wavelength conversion between the channels o the DWDM system. The reason for this is that the wavelength conversion can be made between desired channels.

The operation of the optical modulator 11 has been described typically using the expression ([Expression 1]). The characteristic feature of the invention resides in that the input signal light 1 can be modulated by the beat component of the modulating signal 2 consisting of a plurality of wavelength components. Therefore, it should be understood that the invention is not limited to the optical modulator 11 defined by the expression ([Expression 11]).

In the above description, the internal configuration of the optical modulator 11 is not referred to, in particular. The optical modulator 11 may be any modulator if it is capable of generating wavelength conversion components. Examples of the modulator of the type using an electric signal for the modulating signal are an amplitude modulator and a phase modulator, both utilizing an electrooptical effect. Examples of the modulator of the type using an optical signal for the modulating signal are an amplitude modulator and a phase modulator, both utilizing an optical Kerr effect. Examples of the modulator of this type are an amplitude modulator and a phase modulator, both utilizing a nonlinear optical effect. It is evident that the invention is not limited to the above ones.

Detailed description on the wavelength select means 13 is also not made. The wavelength select means 13 may be any means if it has a function that it allows only necessary wavelength components to selectively pass therethrough, and block, and inhibits unnecessary wavelength components from passing therethrough. Such a wavelength select means may be dielectric multilayered film filter, Bragg diffraction grating, etalon plate, optical interferometer, dispersion prism, etc. It is evident that the wavelength select means is not limited to those enumerated ones.

Further description of the invention will be given by using some specific numerical examples,

### NUMERICAL EXAMPLE 1

Let us consider the wavelength conversion from one channel to another channel of which the wavelength band is lower than that of the former channel by one channel (viz., the wavelength is long or frequency is low) in the DWDM system in which the wavelength interval is 0.4 nm in a 1.55 μm wavelength band. In the arrangement of FIG. 1, the modulating signal generator 12 is generating a microwave of 50 GHz. When the microwave is input to the optical modulator 11, components which are analogous in shape to and are shifted ±50 GHz with respect to the frequency of the input signal light 1 appear in the output signal light 3 of the modulator. If the wavelength select means 13 is designed so as to allow only the frequency component shifted −50 GHz to pass therethrough. Then, an output signal light 4 of which the frequency is shifted by −50 GHz from the frequency of the input signal light 1, is output from the device.

### NUMERICAL EXAMPLE 2

Let us consider the wavelength conversion from one channel to another channel of which the wavelength band is higher than that of the former channel by three channels (viz., the wavelength of the former channel is short or frequency is high) in the DWDM system in which the wavelength interval is 0.8 nm in a 1.55 μm wavelength band. In the arrangement of FIG. 1, the modulating signal generator 12 is generating light containing two light components of 281459.8 GHz and 282059.8 GHz. The phase and amplitude of each light component are mathematically expressed by the expression ([Expression 12]). When such light is input to the optical modulator 11, the modulator operates as given by the expression ([Expression 11]). Accordingly, components which are analogous in shape to and are shifted ±300 GHz with respect to the frequency of the input signal light 1 appear in the output signal light 3 of the modulator. If the wavelength select means 13 is designed so as to allow only the frequency component shifted +300 GHz to pass therethrough. Then, an output signal light 4 of which the frequency is shifted by +300 GHz from the frequency of the input signal light 1, is output from the device.

### NUMERICAL EXAMPLE 3

Let us consider the wavelength conversion from one channel to another channel in the DWDM system in which the wavelength interval is 0.4 nm in a 1.55 μm wavelength band. A modulating signal generator 22 shown in FIG. 2 is generating light containing two light components of which the phase and amplitude are defined by the expression ([Expression 12]). A frequency ωs of a beat is controller to be set to 600 GHz by a conversion quantity control unit 24. Accordingly, components which are analogous in shape to and are shifted by an amount as set by the conversion quantity control unit 24 with respect to the frequency of the input signal light 1 appear in the output signal light 3 of the modulator. The wavelength select means 23 is controlled by the conversion quantity control unit 24 so that it allows only the component shifted by −600 GHz of those components to pass therethrough. Accordingly, an output signal light 4 of which the frequency is shifted, by the frequency set by the conversion quantity control unit 24, from that of the input signal light 1, is output from the device.

### EXAMPLE

An example of the optical wavelength conversion device will be described with reference to the drawings. A DWDM system in which the wavelength interval is 0.8 nm in a 1.55 μm wavelength band, will be used for the description. Description will be given every device component.

<Optical Modulator>

In the DWDM system, a channel signal of 1550.0 nm is separated from another channel, and is input as an input signal light 1 to the optical modulator 11 shown in FIG. 1. The input signal light 1 may contain polarized light. Then, a depolarizing filter 31 is inserted in the optical modulator to remove the polarization of the light. The light output from the depolarizing filter is then passed through a polarizer 32 to thereby obtain a linearly polarized light. A light signal is used for the modulating signal 2, and is polarized into a linearly polarized light, by a polarizer 34.

An optical path of the input signal light 5 as is now the linearly polarized light is superposed on an optical path of the modulating signal light 6 as is now the linearly polarized light, by an optical multiplexer 33. The polarizers 32 and 34 are oriented so that the input signal light 5 as is now the linearly polarized light is oriented in polarization by 45° with respect to the modulating signal light 6.

The input signal light 5 and the modulating signal light 6 are incident on an nonlinear optical element 35. When those light propagate through the nonlinear optical element 35, the polarization plane of the input signal light 5 is rotated in orientation in accordance with an intensity of the modulating signal light 6, and hence, is modulated in orientation.

The analyzer 36 extracts only the component having a polarization plane coincident with that of the analyzer, from the modulated light signal 7. The polarization plane of the analyzer 36 is rotated by 90° with respect to that of the polarizer 32. Then, when the intensity of the modulating signal 2 is 0, the input signal light 5 is blocked in its traveling by the analyzer 36. The polarization plane of the input signal light 5 rotates in accordance with an intensity of the modulating signal 2. Accordingly, an intensity of the light passing through the analyzer 36, viz., the output signal light 3 of the modulator, varies in accordance with an intensity of the modulating signal 2. Thus, the optical modulator of the optical Kerr switch type, which is based on the 3rd-order nonlinear optical effect, was constructed.

Light, as the modulating signal 2, which contains two wavelength components of 1062.868 nm and 1065.134 nm, which are equal in intensity, is incident on the modulator. That is, in the expression ([Expression 12]), the relation where ωk=281759.8 GHz and ωs=300 GHz holds.

Chalcogenide glass composed of As₄₀S₆₀, Ge₁₅As₂₅S₆₀, Ge₅As₃₅S₅₅Se₅ (in mol %) was used for the nonlinear optical element 35. A response rate of the rotation of the polarization plane of the nonlinear optical material is on the order of 0.1 ps (=10⁻¹³ second). Accordingly, it responds to an intensity variation of the modulating signal light, of which a changing rate is on the order of THz (=1000 GHz, 10⁻¹² second). However, it does not respond to an intensity variation of the modulating signal at ωk=384349.3 GHz (=2.6×10⁻¹⁵ second). Therefore, the component of ωk does not produce any effect. However, it sufficiently responds to an intensity variation of the modulating signal light of ωs=300 GHz, and the input light signal can be modulated by a signal of ωs=300 GHz.

Thus, the optical modulator 11 amplitude-modulates the input signal light 1 by he modulating signal 2, and produces the amplitude-modulated signal as the output signal light 3.

Incidentally, the output signal light 3 thus produced from the optical modulator contains a component of which the wavelength is equal to that of the input signal light 5 as the linearly polarized light, a component of which the wavelength is changed by a length which is ±n (n=natural number of 2 or larger) of ωs, produced according to the expression ([Expression 7]), and a component of which the wavelength is equal to that of the modulating signal 2, in addition to the component of which the wavelength is changed by ±ωs as shown in the expression ([Expression 4]) and changed

<Modulation Signal Generator>

An Nd⁺³ optical fiber laser shown in FIG. 4 was used for the modulating signal generator 12.

A gain medium was an optical fiber 41 containing 0.1 wt % of Nd₂O₃, and pumping light of 800 nm was introduced from a semiconductor laser 43 with an optical-fiber pig tail into the modulating signal generator, by using a WDM coupler 42. An optical fiber Bragg diffraction grating, formed through the interference exposure by ultraviolet rays, was used for an end mirror 44 and an output coupler 45.

The end mirror 44 was designed so as to have a reflectivity which is increased by 1062.868±0.01 nm and 1065.134±0.1 nm. The output coupler 45 was designed to have a transmission coefficient of about 1% at 1062 nm to 1066 nm.

In this way, the modulating signal 2 was obtained which contains two wavelength components of 1062.868 nm and 1065.134 nm, both being are equal in intensity.

<Wavelength Select Means>

The output signal light 3 of the modulator is input to the wavelength select means 13. The wavelength select means 13 is a narrow band-pass filter. The wavelength select means allows light of a 0.8 nm bandwidth, which ranges from 1547.2 nm to 1548.0 nm with respect to 1547.6 nm to pass therethrough, and rejects light of wavelengths except the above. A dielectric multilayered film filter was used, which results from a multilayered film formation by vacuum film deposition process

With such a construction, a DWDM channel signal of 1550.0 nm was converted to a channel signal of 1547.6 n, whereby a wavelength conversion of +300 GHz was realized.

### EFFECT OF THE INVENTION

The thus constructed invention has the following advantages.

The optical wavelength conversion device of the invention is capable of performing a wavelength conversion at high speed and good stability, and with high performances. Further, there is no need of converting the optical signal to the electrical signal, during the process of the wavelength conversion of the optical signal. This feature provides an optical wavelength conversion device operable at extremely high speed. Further, a wavelength conversion width is defined by a beat component containing a plurality of optical signal modulating signals to thereby ensure a wavelength conversion at the large conversion width. Further, a quantity of wavelength conversion may be set at a desired value. These features are well applicable for the channel conversion in the optical communication of the DWDM communication system.

$$\begin{matrix}\begin{matrix}{I}_{1} = Ic [ sin ( {ω}_{c} t ) + \frac{1}{2 Ic} {\sum }_{i} {Ip}_{i} \\ \{ cos ( ( {ω}_{c} - {ω}_{i} ) t - {α}_{i} ) - cos ( ( {ω}_{c} + {ω}_{i} ) t + {α}_{i} ) \} ]\end{matrix} & [ Expression 1 ] \\ \begin{matrix}{I}_{3} = Ic \{ 1 + \frac{Is}{Ic} sin ( {ω}_{s} t ) \} \times \\ [ sin ( {ω}_{c} t ) + \frac{1}{2 Ic} {\sum }_{i} {Ip}_{i} \{ cos ( ( {ω}_{c} - {ω}_{i} ) t - {α}_{i} ) - \\ cos ( ( {ω}_{c} + {ω}_{i} ) t + {α}_{i} ) \} ] \\ = {I}_{1} + \frac{Is}{2} [ cos ( {ω}_{c} - {ω}_{s} ) t + \\ \frac{1}{2 Ic} {\sum }_{i} {Ip}_{i} \{ - sin ( ( ( {ω}_{c} - {ω}_{s} ) - {ω}_{i} ) t - {α}_{i} ) + \\ sin ( ( {ω}_{c} - {ω}_{s} ) + {ω}_{i} ) t + {α}_{i} ) \} ] + \\ \frac{Is}{2} [ - cos ( {ω}_{c} + {ω}_{s} ) t + \frac{1}{2 Ic} {\sum }_{i} {Ip}_{i } \{ sin ( ( ( {ω}_{c} + \\ {ω}_{s} ) - {ω}_{i} ) t - {α}_{i} - sin ( ( ( {ω}_{c} + {ω}_{s} ) + {ω}_{i} ) t + {α}_{i} ) \} ] \\ = {I}_{1} + \frac{Is}{2} [ sin ( ( {ω}_{c} - {ω}_{s} ) t + \frac{π}{2} ) + \\ \frac{1}{2 Ic} {\sum }_{i} {Ip}_{i} \{ cos ( ( ( {ω}_{c} - {ω}_{s} ) - {ω}_{i} ) t - {α}_{i} + \frac{π}{2} ) ) - \\ cos ( ( ( {ω}_{c} - {ω}_{s} ) + {ω}_{i} ) t + {α}_{i} + \frac{π}{2} ) ) \} ] - \\ \frac{Is}{2} [ ( sin ( {ω}_{c} + {ω}_{s} ) t + \frac{π}{2} ) + \\ \frac{1}{2 Ic} {\sum }_{i} {Ip}_{i} \{ cos ( ( ( {ω}_{c} + {ω}_{s} ) - {ω}_{i} ) t - {α}_{i} + \frac{π}{2} ) ) - \\ cos ( ( ( {ω}_{c} + {ω}_{s} ) + {ω}_{i} ) t + {α}_{i} + \frac{π}{2} ) ) \} ]\end{matrix} & [ Expression 4 ] \\ {I}_{3} = ( 1 + \frac{1}{Ic} {\sum }_{n} {( {a}_{n} {I}_{2} )}^{n} ) {I}_{1} & [ Expression 6 ] \\ \begin{matrix}{I}_{3} = {I}_{1} + \frac{Is}{2} [ {\sum }_{n} {b}_{n} {sin}^{n} ( ( {ω}_{c} - n {ω}_{s} ) t + \frac{π}{2} ) + \\ \frac{1}{2 Ic} {\sum }_{i} {Ip}_{i} \{ {\sum }_{n} {c}_{n} {cos}^{n} ( ( ( {ω}_{c} - n {ω}_{s} ) - \\ {ω}_{i} ) t - {α}_{i} + \frac{π}{2} ) ) - {\sum }_{n} {c}_{n} {cos}^{n} ( ( ( {ω}_{c} - n {ω}_{s} ) + \\ {ω}_{i} ) t + {α}_{i} + \frac{π}{2} ) ) \} ] - \frac{Is}{2} [ {\sum }_{n} {b}_{n} {sin}^{n} ( ( {ω}_{c} + \\ n {ω}_{s} ) t + \frac{π}{2} ) + \frac{1}{2 Ic} {\sum }_{i} {Ip}_{i} \{ {\sum }_{n} {c}_{n } {cos}^{n} ( ( ( {ω}_{c} + \\ n {ω}_{s} ) - {ω}_{i} ) t - {α}_{i} + \frac{π}{2} ) ) - \\ {\sum }_{n} {c}_{n} {cos}^{n} ( ( ( {ω}_{c} + n {ω}_{s} ) + {ω}_{i} ) t + {α}_{i} + \frac{π}{2} ) ) \} ]\end{matrix} & [ Expression 7 ] \\ {I}_{3} = \{ \begin{matrix}u \cdot {I}_{1} & ON \\ υ \cdot {I}_{1} & OFF\end{matrix} , u > υ & [ Expression 8 ] \\ {I}_{3} = \{ \begin{matrix}u \cdot {I}_{1} & sin ( {ω}_{s} ) t \geq 0 \\ υ \cdot {I}_{1} & sin ( {ω}_{s} ) t < 0\end{matrix} , u > υ & [ Expression 9 ] \\ \begin{matrix}{I}_{3} = \{ \begin{matrix}u \cdot {I}_{1} & sin ( {ω}_{s} ) t \geq 0 \\ υ \cdot {I}_{1} & sin ( {ω}_{s} ) t < 0\end{matrix} \\ = \{ \frac{2 ( u - υ )}{π} ( {\sum }_{n}^{∞} \frac{sin ( 2 n - 1 ) {ω}_{s} t}{2 n - 1} ) + \frac{1 + 2 υ}{2} \} \cdot {I}_{1}\end{matrix} & [ Expression 10 ] \\ \begin{matrix}{I}_{2} = {I}_{k} sin ( {ω}_{k} t ) \times {I}_{B} \\ {I}_{3} = ( 1 + \frac{1}{{I}_{k}} {I}_{B} ) {I}_{2}\end{matrix} & [ Expression 11 ] \\ \begin{matrix}{I}_{2} = {I}_{k} sin ( {ω}_{k} t ) \times {I}_{B} \\ = {I}_{k} sin {ω}_{k} t \times sin {ω}_{s} t \\ = \frac{{I}_{k}}{2} \{ cos ( {ω}_{k} - {ω}_{s} ) t - cos ( {ω}_{k} + {ω}_{s} ) t \}\end{matrix} & [ Expression 12 ]\end{matrix}$$

What is claimed is:

1. An optical wavelength conversion device comprising:
a modulating signal generating unit for generating a modulating signal;
an optical modulating unit for modulating input light by said modulating signal; and
wavelength select means for extracting only a necessary component from an optical signal generated by said optical modulating unit.

2. An optical wavelength conversion device according to claim 1, wherein said optical modulating unit is an amplitude modulator.

3. An optical wavelength conversion device according to claim 1, wherein said optical modulating unit is a phase modulator.

4. An optical wavelength conversion device according to any of claims 1 to 3, wherein said modulating signal is an electrical signal.

5. An optical wavelength conversion device according to any of claims 1 to 3, wherein said modulating signal is an optical signal.

6. An optical wavelength conversion device according to claim 5, wherein said optical signal consists of light of a plurality of wavelength components.

7. An optical wavelength conversion device according to claim 5, wherein a wavelength relationship between an input light and an output light is controlled by controlling a wavelength of said optical signal.

8. A method of obtaining output light by converting wavelength of input light, comprising the steps of:
generating a modulating signal;
modulating input light by the modulating signal so as to obtain intermediate light containing an input light component and a wavelength-converted light component; and
extracting the wavelength-converted light component as the output light from the intermediate light.

9. A method according to claim 8, wherein the modulating signal has a predetermined frequency, and the wavelength-converted component has a characteristic of the input light with its frequency shifted by an amount of the predetermined frequency of the modulating signal.

10. A method according to claim 8, wherein the modulating signal has a predetermined beat component corresponding to a beat of the modulating signal including a plurality of wavelength components, and the wavelength-converted component has a characteristic of the input light with its frequency shifted by an amount of the predetermined beat component of the modulating signal.
